(19) United States
(12) Patent Application Publication
(10) Pub. No.: US 2017/0123375 A1
(43) Pub. Date: May 4, 2017

(54) APPARATUS AND METHOD FOR GENERATING HOLOGRAM

(71) Applicant: ELECTRONICS AND TELECOMMUNICATIONS RESEARCH INSTITUTE, Daejeon (KR)

(72) Inventor: Seung-Taik OH, Seoul (KR)

(21) Appl. No.: 15/343,105

(22) Filed: Nov. 3, 2016

(30) Foreign Application Priority Data
Nov. 4, 2015 (KR) 10-2015-0154603

(51) Int. Cl. G03H 1/08; G03H 1/22; G03H 1/16

(52) U.S. Cl. CPC G03H 1/08; G03H 1/16; G03H 1/2294; G03H 1/0841

(57) ABSTRACT

An apparatus for generating a hologram in accordance with an embodiment of the present invention includes: a frequency component data generating part configured for generating frequency component data comprising a spatial frequency component of a spherical wave generated at a sampling point of a graphic model; an input part configured for receiving a generation angle and a generation position corresponding to a plane hologram; a frequency component search part configured for extracting a hologram target component for a main spatial frequency vector having a most similar direction with the generation angle from the frequency component data; an angular spectrum generating part configured for generating an angular spectrum by multiplying a predetermined factor to the hologram target component and propagating the angular spectrum according to the generation position; and a hologram generating part configured for generating the plane hologram by applying inverse Fourier transform to the angular spectrum.

### CROSS-REFERENCE TO RELATED APPLICATIONS

This application claims the benefit of Korean Patent Application No. 10-2015-0154603, filed with the Korean Intellectual Property Office on Nov. 4, 2015, the disclosure of which is incorporated herein by reference in its entirety.

### BACKGROUND

1. Technical Field

The present invention relates to generating a hologram, more specifically to generating a holographic image that can be reproduced in every direction on a horizontal plane through a plane spatial light modulator.

2. Background Art

A hologram is a three-dimensional image providing a natural stereoscopic sense to an observer, as if an actual object is present, without the use of an additional apparatus such as eyeglasses. With the advancement of digital technologies, there has been an accelerated development in digital hologram technologies. Particularly, there are a number of studies for computer generated hologram (CGH), in which a hologram is generated by numerically calculating light waves generated by an object. The biggest advantage of CGH is that it is possible to generate a hologram for a virtual model. Unlike an analog hologram, the CGH can be optically reproduced by a spatial light modulator (SLM), which is a digital display device.

The general CGH is generated by writing object waves on a rectangular plane, which is often referred to as a hologram plane. The object waves being written on the hologram plane are only a part of the entire object waves, and if the object waves were to be written in a wider area, a greater size of the hologram plane would have be configured. In addition, in order to write the object waves accurately, pixel distances would have to be smaller, based on the sampling theorem. As a result, the overall number of pixels of the hologram is increased. And theoretically, if the object waves were to be written in an 180-degree section, the pixel distance would have to be decreased to one half of the wavelengths of light, and thus the pixels on the hologram plane would be increased to a number that is impossible to process.

Meanwhile, if a cylindrical hologram were used instead of a plane hologram, it would be possible to write the object waves in a 180-degree section with a finite number of pixels, which can be processed. However, it is difficult to produce a cylindrical SLM, and the diffraction equation between curved surfaces is inefficient for computing the hologram.

### SUMMARY

The present invention provides an apparatus and a method for generating a hologram that can generate a plane hologram corresponding to any direction for an object using a spatial frequency component corresponding to a cylindrical grid.

According to an aspect of the present invention, an apparatus for generating a hologram includes: a frequency component data generating part configured for generating frequency component data comprising a spatial frequency component of a spherical wave generated at a sampling point of a graphic model; an input part configured for receiving a generation angle and a generation position corresponding to a plane hologram; a frequency component search part configured for extracting a hologram target component for a main spatial frequency vector having a most similar direction with the generation angle from the frequency component data; an angular spectrum generating part configured for generating an angular spectrum by multiplying a predetermined factor to the hologram target component and propagating the angular spectrum according to the generation position; and a hologram generating part configured for generating the plane hologram by applying inverse Fourier transform to the angular spectrum.

The frequency component data generating part may generate the frequency component data comprising a spatial frequency component for a spatial frequency vector corresponding to a grid point on a cylindrical grid among spatial frequency vectors forming an angle of 90 degrees or less with a normal vector at each sampling point.

The cylindrical grid may be a grid formed in a cylindrical shape on a three-dimensional coordinate system indicating a direction of a spatial frequency vector, and the grid point may correspond to a spatial frequency vector having a direction corresponding to a position of the grid point on the three-dimensional coordinate system.

The frequency component data may be an array comprising the spatial frequency component in an order based on the position of the grid point on the cylindrical grid.

According to another aspect of the present invention, a method for generating a hologram by an apparatus for generating a hologram includes: generating frequency component data comprising a spatial frequency component of a spherical wave generated at a sampling point of a graphic model; receiving a generation angle and a generation position corresponding to a plane hologram from a user; extracting a hologram target component for a main spatial frequency vector, which has a most similar direction with the generation angle; generating an angular spectrum by multiplying a predetermined factor to the hologram target component and propagating the angular spectrum according to the generation position; and generating the plane hologram by applying inverse Fourier transform to the angular spectrum.

The frequency component data generating part may generate the frequency component data comprising a spatial frequency component for a spatial frequency vector corresponding to a grid point on a cylindrical grid among spatial frequency vectors forming an angle of 90 degrees or less with a normal vector at each sampling point.

The cylindrical grid may be a grid formed in a cylindrical shape on a three-dimensional coordinate system indicating a direction of a spatial frequency vector, and the grid point may correspond to a spatial frequency vector having a direction corresponding to a position of the grid point on the three-dimensional coordinate system.

The frequency component data may be an array comprising the spatial frequency component in an order based on the position of the grid point on the cylindrical grid.

As described above, according to an embodiment of the present invention, it is possible to quickly generate a plane hologram based on any direction of a specific graphic model.

### BRIEF DESCRIPTION OF DRAWINGS

FIG. 1 is a block diagram illustrating an apparatus for generating a hologram in accordance with an embodiment of the present invention.

FIG. 2 illustrates spherical waves generated at each sampling point by the apparatus for generating a hologram in accordance with an embodiment of the present invention.

FIG. 3 illustrates a normal vector and a spatial frequency vector at a sampling point of a graphic model calculated by the apparatus for generating a hologram in accordance with an embodiment of the present invention.

FIG. 4 illustrates a grid being mapped with each spatial frequency component of frequency component data generated by the apparatus for generating a hologram in accordance with an embodiment of the present invention.

FIG. 5 is a flow diagram illustrating how a hologram is generated by the apparatus for generating a hologram in accordance with an embodiment of the present invention.

FIG. 6 illustrates a computer system in which the apparatus for generating a hologram in accordance with an embodiment of the present invention is realized.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

When one element is described as being “connected” or “accessed” to another element, it shall be construed that the one element may be directly connected or accessed to the other element, but it shall be also construed that, unless otherwise described, the one element may be connected or accessed to the other element via yet another element.

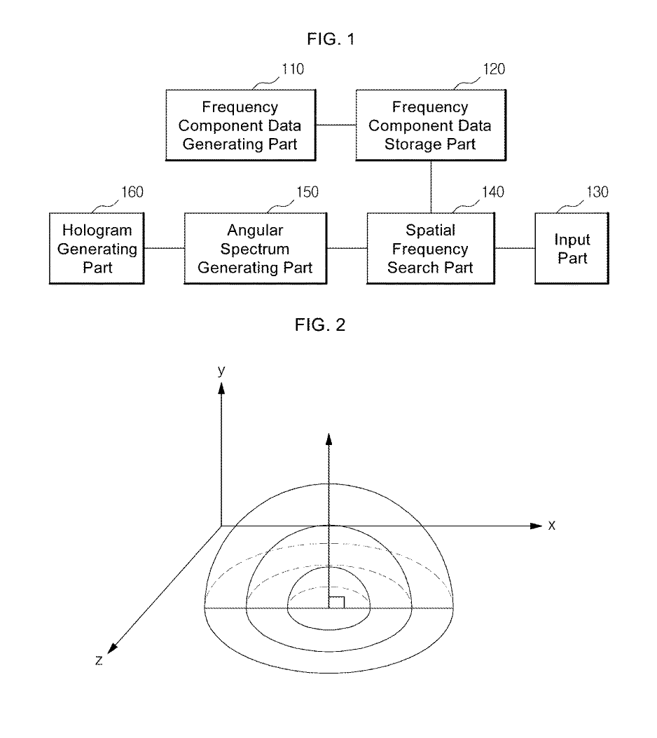

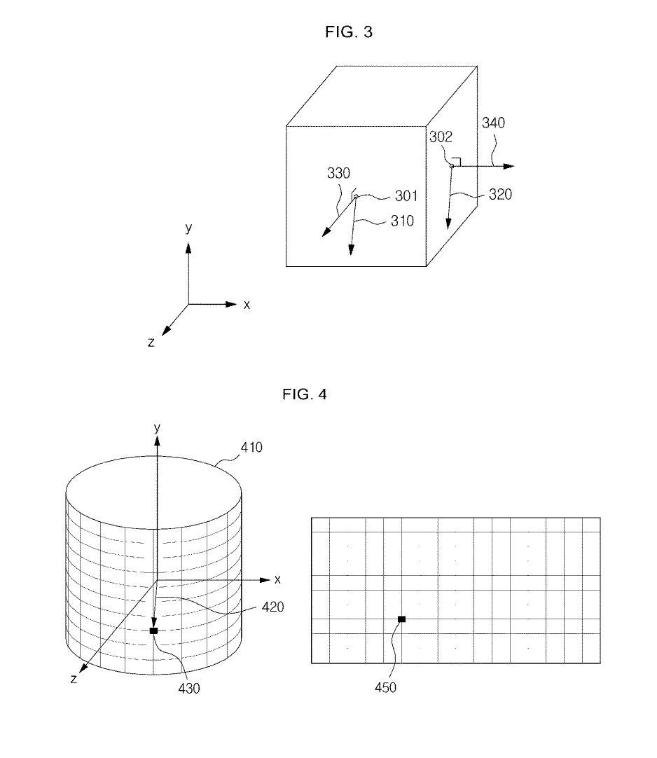

FIG. 1 is a block diagram illustrating an apparatus for generating a hologram in accordance with an embodiment of the present invention. FIG. 2 illustrates spherical waves generated at each sampling point by the apparatus for generating a hologram in accordance with an embodiment of the present invention. FIG. 3 illustrates a normal vector and a spatial frequency vector at a sampling point of a graphic model calculated by the apparatus for generating a hologram in accordance with an embodiment of the present invention. FIG. 4 illustrates a grid being mapped with each spatial frequency component of frequency component data generated by the apparatus for generating a hologram in accordance with an embodiment of the present invention.

Referring to FIG. 1, the apparatus for generating a hologram includes a frequency component data generating part 110, a frequency component data storage part 120, an input part 130, a spatial frequency search part 140, an angular spectrum generating part 150 and a hologram generating part 160.

The frequency component data generating part 110 has a graphic model inputted thereto, computes a sampling point by sampling a graphic mesh model according to a predetermined rule, and generates frequency component data by mapping a spatial frequency component of a spherical wave generated at each sampling point to each point of a cylindrical grid. For example, the apparatus for generating a hologram assumes that a spherical wave is proliferated in the form of a hemisphere at each sampling point of the graphic model, as shown in FIG. 2. That is, the frequency component data generating part 110 generates the frequency component data by considering a spatial frequency vector forming an angle of 90 degrees or less with a normal vector of each sampling point.

For example, in a case where two sampling points 301, 302 have normal vectors 330, 340 formed, respectively, as shown in FIG. 3, the frequency component data generating part 110 may store a sum of spatial frequency components for spatial frequency vectors 310, 320 forming 90 degrees or less with the normal vectors, respectively, in the frequency component data. Here, the spatial frequency component of a spatial frequency vector may be computed using the below Equation 2 derived from the below Equation 1.

$$\begin{matrix}\begin{matrix}U ( x ) = \int {\int }_{k ∈ {S}_{1 / λ}} exp ( j2 π k \cdot ( x - {x}_{0} ) ) d S \\ = \int {\int }_{k ∈ {S}_{1 / λ}} A exp ( j2 π k \cdot x ) d S\end{matrix} & [ Equation 1 ] \\ A = exp ( - j2 π k \cdot {x}_{0} ) & [ Equation 2 ]\end{matrix}$$

Here, λ is a wave of light; S_{1/A} is a spherical surface having a radius of 1/λ in a three-dimensional frequency space; k is a spatial frequency vector; x₀ is a starting point of a spherical wave; x is a point oriented by the spherical wave; and A is a spatial frequency component for the spatial frequency vector k.

Here, the frequency component data stores a spatial frequency component of a spatial frequency vector corresponding to each grid point of a cylindrical grid 410 formed on a three-dimensional coordinates system indicating spatial frequency vectors, as shown in FIG. 4. In other words, the spherical wave generated at each sampling point may be expressed with a plurality of spatial frequency vectors, and a portion of each spatial frequency vector may be a spatial frequency vector indicating a direction corresponding to the grid point of FIG. 4. That is, since one spatial frequency vector 310 of the spherical wave generated from the sampling point 301 has a direction corresponding to reference number 420 of FIG. 4, the frequency component data generating part 110 may store the spatial frequency component of the spatial frequency vector 310 at a position corresponding to the grid point 430.

Here, since one spatial frequency vector 320 of the spherical wave generated from the sampling point 302 also has a direction corresponding to reference number 420 of FIG. 4, the frequency component data generating part 110 may store a sum of the spatial frequency component of the spatial frequency vector 310 and the spatial frequency component of the spatial frequency vector 320 at a position corresponding to the grid point 430. Here, the frequency component data may be an array in which the spatial frequency components are stored in an order based on the position of each grid point. That is, in a case where the cylindrical grid is spread in a plane form as shown with reference number 450 in FIG. 4, the frequency component data may be a two-dimensional array form in which the spatial frequency component corresponding to each grid point is stored.

The frequency component data generating part 110 generates the frequency component data by applying the above steps to every spatial frequency vector corresponding to the grid point among the spatial frequency vectors forming an angle of 90 degrees or less with the normal vector at each sampling point. Accordingly, since the frequency component data includes the sum of spatial frequency components of the spatial frequency vectors corresponding to the sampling points corresponding to the direction of each grid point, it is possible for the frequency component data to include the components of the spatial frequency corresponding to 360-degree directions about a center of a graphic model, as the sampling points are dispersed in every direction of the graphic model. If an interference is occurred between the graphic model and a ray determined by a particular spatial frequency vector, the frequency component data generating part 110 may exclude the spatial frequency component of the very spatial frequency vector from the above-described sum of spatial frequency components.

The frequency component data generating part 110 stores the frequency component data in the frequency component data storage part 120.

The frequency component data storage part 120 stores the frequency component data, searches for a spatial frequency component of a spatial frequency vector in a specific direction according to a request for search of spatial frequency by the spatial frequency search part 140, and provides the searched spatial frequency component to the spatial frequency search part 140.

The input part 130 receives a generation angle, which is an angle between a line connecting a center point of the plane hologram to be generated to a distal point on a hologram space and a z-axis direction of the hologram space, and a generation position, which is the position of the center point of the hologram to be generated, from a user. The input part 130 sends the generation position and the generation angle to the spatial frequency search part 140. The spatial frequency search part 140 searches for a spatial frequency component corresponding to a spatial frequency vector (“main spatial frequency vector” hereinafter) of the frequency component data that is closest to the generation angle. The spatial frequency search part 140 extracts spatial frequency components (“hologram target components” hereinafter) corresponding to grid points located within a predetermined range of the grid point corresponding to the main spatial frequency vector from the frequency component data. For example, the spatial frequency search part 140 may determine a spatial frequency vector, among the spatial frequency vectors corresponding to the grid points, having a smallest angle with a reference spatial frequency vector, which has a directional component based on the generation angle, as the main spatial frequency vector. Here, using the fact that the grid points are configured with equal intervals, the spatial frequency search part 140 may quickly find the main spatial frequency vector by multiplying with an index, without calculating the angle between two vectors.

Since a spatial frequency area required for generation of the plane hologram is determined by a diffraction angle of the hologram, it is possible for the spatial frequency search part 140 to quickly extract the spatial frequency area using the index of each grid point. Here, the index of the grid point may be coordinates of each grid point when the cylindrical grid is rendered in the plane form, as shown in FIG. 4. Specifically, when the cylindrical grid is rendered in the plane form, the index of the grid point located far left on the top row may be (0, 0). In a case where the index of the grid point corresponding to the main frequency vector is (i, j), it may be possible to detect a grid data area containing grid points located between (i−a) and (i+a) on a horizontal axis and between (j−b) and (j+b) on a vertical axis. Here, a and be are parameters determined by the diffraction angle of the hologram and may be predetermined constants corresponding to the diffraction angle. The extracted spatial frequency area is rotated by as much as the generation angle such that the main spatial frequency vector is oriented to the z-axis. The spatial frequency search part 140 sends the hologram target components to the angular spectrum generating part 150.

The angular spectrum generating part 150 generates an angular spectrum by multiplying a factor 1/γ, in which an area element is considered, with each of the hologram target components and converting the hologram target components into a plane hologram area. Here, γ is a z-axis component of the spatial frequency vector corresponding to each of the hologram target components. Here, the angular spectrum generating part 150 propagates the angular spectrum by as much as a projection distance (i.e., a distance from a distal point of the hologram space to the center point of the plane hologram) based on the generation position inputted through the input part 130. The angular spectrum generating part 150 sends the propagated angular spectrum to the hologram generating part 160.

The hologram generating part 160 generates the plane hologram based on the generation angle and the generation position by applying inverse Fourier transform to the angular spectrum.

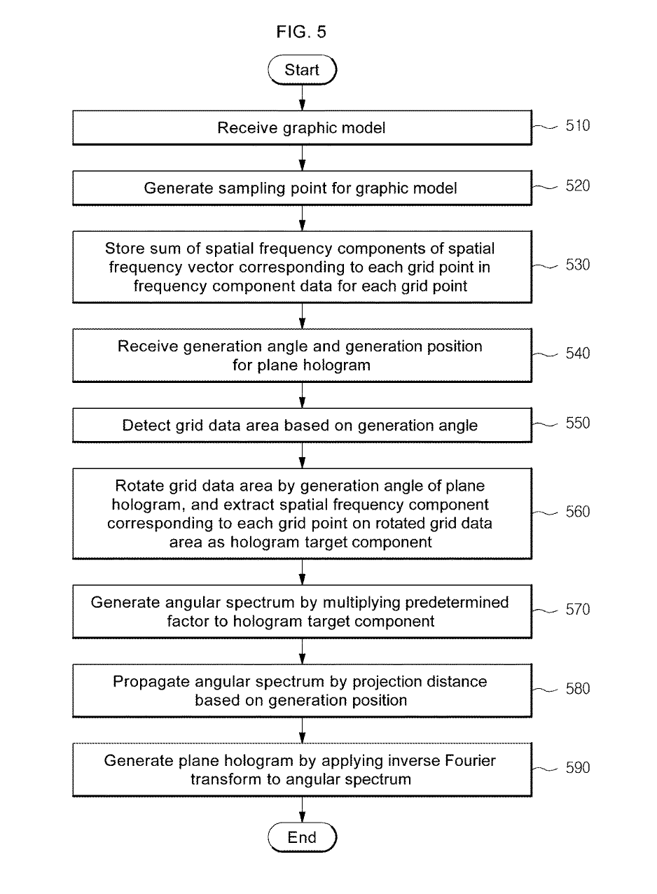

FIG. 5 is a flow diagram illustrating how a hologram is generated by the apparatus for generating a hologram in accordance with an embodiment of the present invention. Although the steps described below are carried out by their respective functional units included in the apparatus for generating a hologram, the functional units will be collectively referred to as the apparatus for generating a hologram, for clear, concise description of the invention.

Referring to FIG. 5, in step 510, the apparatus for generating a hologram is inputted with a graphic model.

In step 520, the apparatus for generating a hologram generates a sampling point for the graphic model. For example, the apparatus for generating a hologram may generate the sampling point by sampling a point corresponding to a predetermined rule among points that are present on a surface of the graphic model.

In step 530, the apparatus for generating a hologram stores a sum of spatial frequency components of a spatial frequency vector corresponding to each grid point in frequency component data for each grid point. Here, the spatial frequency vector corresponding to each sampling point may be a spatial frequency vector corresponding to a spherical wave being proliferated in the form of a hemisphere. Moreover, the grid point may be a point corresponding to an intersection of a cylindrical grid formed on a three-dimensional space indicating the spatial frequency vector, as shown with reference number 410 in FIG. 4.

In step 540, the apparatus for generating a hologram is inputted with a generation angle and a generation position for a plane hologram from a user.

In step 550, the apparatus for generating a hologram detects a grid data area based on the generation angle. For example, it is possible to search for a main spatial frequency vector, which is a spatial frequency vector among the spatial frequency vectors corresponding to the grid points that is closest to the generation angle, and detect the grid data area, which is an area containing grid points located within a predetermined range, in horizontal and vertical directions, of the grid point corresponding to the main spatial frequency vector.

In step 560, the apparatus for generating a hologram rotates the grid data area by as much as the generation angle of the plane hologram (here, the direction of the main spatial frequency vector on the rotated grid data area coincides with the z-axis of a hologram space) and extracts the spatial frequency component corresponding to each grid point on the rotated grid data area as a hologram target component.

In step 570, the apparatus for generating a hologram generates an angular spectrum by multiplying a predetermined factor to the hologram target component. For example, the apparatus for generating a hologram generates the angular spectrum by multiplying a factor in which an area element is considered, to each of the hologram target components and converting the hologram target components into a plane hologram area. Here, is a z-axis component of the spatial frequency vector corresponding to each of the hologram target components.

In step 580, the apparatus for generating a hologram propagates the angular spectrum by as much as a projection distance (i.e., a distance from a distal point of the hologram space to the center point of the plane hologram) based on the generation position.

In step 590, the apparatus for generating a hologram generates the plane hologram by applying inverse Fourier transform to the angular spectrum.

Accordingly, with the apparatus for generating a hologram in accordance with an embodiment of the present invention, it is possible to quickly generate the plane hologram conforming with the user-inputted generation angle and generation position by referencing the pre-generated frequency component data.

The apparatus for generating a hologram in accordance with an embodiment of the present invention described above may be realized in a computer system.

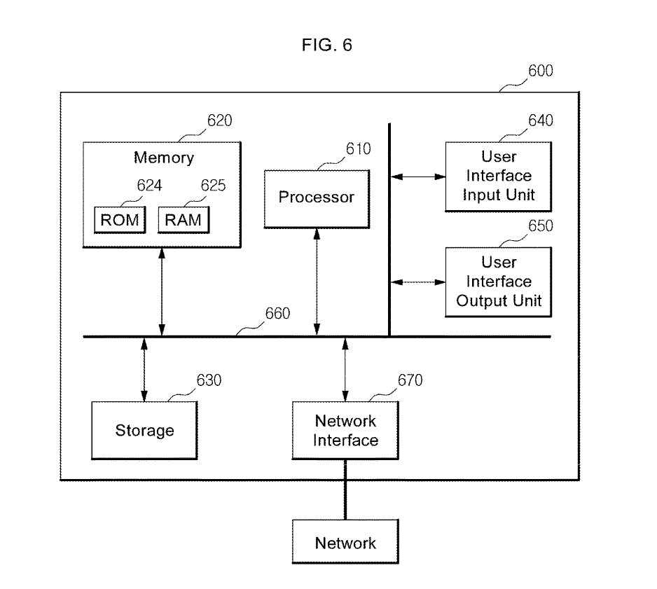

FIG. 6 illustrates a computer system in which the apparatus for generating a hologram in accordance with an embodiment of the present invention is realized.

An embodiment of the present invention may be realized in a computer system, for example, as a computer-readable recording medium. As illustrated in FIG. 6, a computer system 600 may include at least one of elements consisting of a processor 610, a memory 620, a storage 630, a user interface input unit 640 and a user interface output unit 650, which are communicable with one another through a bus 660. Moreover, the computer system 600 may further include a network interface 670 for accessing a network. The processor 610 may be a CPU or a semiconductor device for running process instructions stored in the memory 620 and/or storage 630. The memory 620 and the storage 630 may include various types of volatile/non-volatile memory media. For example, the memory 620 may include ROM 624 and RAM 625.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An apparatus for generating a hologram, comprising:
a frequency component data generating part configured for generating frequency component data comprising a spatial frequency component of a spherical wave generated at a sampling point of a graphic model;
an input part configured for receiving a generation angle and a generation position corresponding to a plane hologram;
a frequency component search part configured for extracting a hologram target component for a main spatial frequency vector having a most similar direction with the generation angle from the frequency component data;
an angular spectrum generating part configured for generating an angular spectrum by multiplying a predetermined factor to the hologram target component and propagating the angular spectrum according to the generation position; and
a hologram generating part configured for generating the plane hologram by applying inverse Fourier transform to the angular spectrum.

2. The apparatus of claim 1, wherein the frequency component data generating part is configured for generating the frequency component data comprising a spatial frequency component for a spatial frequency vector corresponding to a grid point on a cylindrical grid among spatial frequency vectors forming an angle of 90 degrees or less with a normal vector at each sampling point.

3. The apparatus of claim 2, wherein the cylindrical grid is a grid formed in a cylindrical shape on a three-dimensional coordinate system indicating a direction of a spatial frequency vector, and
wherein the grid point corresponds to a spatial frequency vector having a direction corresponding to a position of the grid point on the three-dimensional coordinate system.

4. The apparatus of claim 3, wherein the frequency component data is an array comprising the spatial frequency component in an order based on the position of the grid point on the cylindrical grid.

5. A method for generating a hologram, the hologram being generated by an apparatus for generating a hologram, the method comprising:
generating frequency component data comprising a spatial frequency component of a spherical wave generated at a sampling point of a graphic model;
receiving a generation angle and a generation position corresponding to a plane hologram from a user;
extracting a hologram target component for a main spatial frequency vector, which has a most similar direction with the generation angle;
generating an angular spectrum by multiplying a predetermined factor to the hologram target component and propagating the angular spectrum according to the generation position; and
generating the plane hologram by applying inverse Fourier transform to the angular spectrum.

6. The method of claim 5, wherein the frequency component data generating part is configured for generating the frequency component data comprising a spatial frequency component for a spatial frequency vector corresponding to a grid point on a cylindrical grid among spatial frequency vectors forming an angle of 90 degrees or less with a normal vector at each sampling point.

7. The method of claim 6, wherein the cylindrical grid is a grid formed in a cylindrical shape on a three-dimensional coordinate system indicating a direction of a spatial frequency vector, and
wherein the grid point corresponds to a spatial frequency vector having a direction corresponding to a position of the grid point on the three-dimensional coordinate system.

8. The method of claim 7, wherein the frequency component data is an array comprising the spatial frequency component in an order based on the position of the grid point on the cylindrical grid.
